(19) United States
(12) Patent Application Publication
(10) Pub. No.: US 2024/0138430 A1
(43) Pub. Date: May 2, 2024

(54) VEGETABLE MOULDED CHEESE-LIKE FOOD PRODUCT

(71) Applicant: FUJI OIL HOLDINGS INC., Osaka (JP)

(72) Inventors: Hiroshi MIZUNO, Osaka (JP); Masanobu YANAGISAWA, Osaka (JP); Echim CAMELIA, Gent (BE); Verbeeck SABRINA, Gent (BE)

(21) Appl. No.: 18/548,811

(22) PCT Filed: Mar. 28, 2022
(86) PCT No.: PCT/JP2022/014765

§ 371 Date: Sep. 1, 2023

(30) Foreign Application Priority Data
Mar. 31, 2021 (JP) 2021-061233

(51) Int. Cl. A23C 20/02

(52) U.S. Cl. CPC A23C 20/02

(57) ABSTRACT

To provide a vegetable molded cheese-like food product having a sufficiently high hardness with a low saturated fatty acid content and suitable for an intended use. Provided is a vegetable molded cheese-like food product which is an oil-in-water emulsion containing oils and fats of 10 to 40 wt %, starches, and a vegetable protein, in which SFC of the oils and fats in the oil-in-water emulsion is 5% to 50% at 20° C., saturated fatty acid content is 2.5 to 10 wt %, and a ratio of saturated fatty acids to all constituent fatty acids in the oils and fats in the oil-in-water emulsion is less than 70 wt %.

### TECHNICAL FIELD

The present invention relates to a vegetable molded cheese-like food product.

Efforts to achieve sustainable development goal (SDGs) are progressing worldwide.

In particular, it is predicted that animal resources and water resources will be in shortage in the future due to global population growth, and a sense of social crisis against global problems such as “food resource shortage” and “environment” is increasing.

Attempts have been made to this solve global social problems such as “food resource shortage” and “environment” that occur with population growth through plant-derived food materials.

Cheese is a type of dairy product produced by using milk, which is an animal resource collected from cattle, buffalo, sheep, goat, yak, and the like, as a raw material, and undergoing steps such as coagulation and fermentation, often used in combination with other foods in addition to being directly eaten, and used for various dishes such as pizza, pasta, gratin, risotto, cheese fondue, and the like.

Cheese made from milk has an elastic and moderate hardness, and is often distributed and used as molded cheese that has undergone molding processing such as shredding or slicing.

On the other hand, health impairment such as obesity and diabetes associated with an increase in consumption of animal resources is also a problem, and attention is focused on health improvement by dietary life.

In addition, for various reasons, the number of people who need to eat only vegetarian food or select this is also increasing.

In response to such a situation, evaluation of foods using vegetable resources as raw materials is increasing.

Some cheese-like food products using vegetable resources as raw materials have been studied, and among them, as cheese-like food products having hardness, for example, in PATENT LITERATURE 1, a food product having a texture like processed cheese using soy milk, casein, and vegetable oil and fat as main raw materials is proposed, and analysis values of hardness are described, but it does not have hardness enough to be molded into a shape suitable for shredding or slicing.

In order to obtain a cheese-like food product having a hardness suitable for molding processing such as shredding or slicing, physical properties of the product are determined by its formulation, that is, an amount and nature of oils and fats and other raw materials in the product, and a process in which the product is produced.

Processing steps such as emulsification, heating, and tempering affect the physical properties of the product.

The oils and fats are blended in various ways depending on their functional properties, specifically in consideration of influence on physical properties of a final product.

Currently, oils and fats having hard physical properties suitable for the physical properties of the product having hardness can be naturally used in a wide range.

Hydrogenation of liquid oils such as soybean, rapeseed, sunflower, and peanut oil is also called “hardening”, and is widely used as a technique for obtaining the oils and fats having hard physical properties.

Hardening results in conversion of unsaturated fatty acids to saturated fatty acids (SAFA), as well as conversion of cis-unsaturated fatty acids to trans isomers (TFA), both of which contribute to conversion of the liquid oils to solid oils and fats by hydrogenation.

For example, PATENT LITERATURES 2 and 3 propose a semi-hard or hard type vegetable cheese-like food product, but a large amount of saturated fatty acid (SAFA) is blended in order to obtain hard physical properties.

Saturated fatty acids (SAFA) are abundant in natural oils and fats such as cocoa butter, palm oil, palm kernel oil, coconut oil, beef tallow, and the like.

Naturally derived trans-fatty acids (TFA) are found primarily in ruminant oils and fats.

Natural vegetable oils and fats do not contain the trans isomer.

Although high amounts of SAFA and/or TFA are recommended for functional reasons to obtain desired physical properties, in terms of nutrition, consumption of these saturated fatty acids is limited as they increase risk of occurrence of heart disease.

Therefore, public institutions such as WHO disclose recommended upper limits of daily intake of SAFA and TFA.

Therefore, a cheese-like food product capable of reducing the intake of saturated fatty acid (SAFA) is desired.

### CITATION LIST

### Patent Literature

PATENT LITERATURE 1: JP-A-2004-008191
PATENT LITERATURE 2: WO 2020/089384 A
PATENT LITERATURE 3: WO 2020/089385 A

### SUMMARY OF INVENTION

### Problems to be Solved by Invention

Thus, there is a need for a cheese-like food product having a sufficiently high hardness with a low saturated fatty acid content and suitable for an intended use.

### Solution to Problems

As a result of intensive studies on the above problems, the present inventors have found that a vegetable molded cheese-like food product which is an oil-in-water emulsion containing oils and fats of 10 to 40 wt %, starch, and a vegetable protein, in which SFC of the oils and fats is 5% to 50% at 20° C., saturated fatty acid content is 2.5 to 10 wt %, a ratio of saturated fatty acids to all constituent fatty acids in the oils and fats is less than 70 wt %, and a hardness according to a rheometer measurement value at 5° C. of the oil-in-water emulsion is 400 g/19.6 mm² (5 mm diameter circular plunger, table speed 50 mm/min) or more, can solve the above problems, and have completed the present invention.

That is, the present invention includes the following inventions.
(1) A vegetable molded cheese-like food product which is an oil-in-water emulsion containing oils and fats of 10 to 40 wt %, starch, and a vegetable protein, in which SFC of the oils and fats is 5% to 50% at 20° C., saturated fatty acid content is 2.5 to 10 wt %, a ratio of saturated fatty acids to all constituent fatty acids in the oils and fats is less than 70 wt %, and a hardness according to a rheometer measurement value at 5° C. of the oil-in-water emulsion is 400 g/19.6 mm² (5 mm diameter circular plunger, table speed 50 mm/min) or more.
(2) A vegetable molded cheese-like food product obtained by cutting the vegetable molded cheese-like food product according to (1) and having a slice shape, a dice shape, a strip shape, or a shred shape.
(3) The vegetable molded cheese-like food product according to (1) or (2), containing only vegetable raw materials.

### Effects of Invention

According to the present invention, it is possible to provide a vegetable molded cheese-like food product having hardness suitable for molding processing such as shredding or slicing while reducing the intake of saturated fatty acid (SAFA).

### DESCRIPTION OF EMBODIMENTS

The present invention is a vegetable molded cheese-like food product which is an oil-in-water emulsion containing oils and fats of 10 to 40 wt %, starch, and a vegetable protein, in which SFC of the oils and fats is 5% to 50% at 20° C., saturated fatty acid content is 2.5 to 10 wt %, a ratio of saturated fatty acids to all constituent fatty acids in the oils and fats is less than 70 wt %, and a hardness according to a rheometer measurement value at 5° C. of the oil-in-water emulsion is 400 g/19.6 mm² (5 mm diameter circular plunger, table speed 50 mm/min) or more.

Note in the present invention, the term “vegetable” does not mean that animal raw materials are not contained at all, but means that vegetable raw materials are contained in an amount of 50% or more, and preferably 60% or more.

Hereinafter, the present invention will be described in detail.

(Oils and Fats—Oils and Fats Content)

In the vegetable molded cheese-like food product of the present invention, oils and fats content of the oil-in-water emulsion is 10 to 40 wt %, preferably 15 to 30 wt %, and more preferably 23 to 30 wt %, and it is considered that, in the oils and fats content, the oils and fats form a better crystalline network, and aging of starches proceeds, so that hardness suitable for molding processing such as shredding or slicing can be imparted to the vegetable molded cheese-like food product.

(Oils and Fats—Saturated Fatty Acid Content)

In the vegetable molded cheese-like food product of the present invention, the saturated fatty acid content in the oils and fats in the oil-in-water emulsion is 2.5 to 10 wt % and the ratio of the saturated fatty acids to all constituent fatty acids in the oils and fats is less than 70 wt %, it is preferable that the saturated fatty acid content in the oils and fats in the oil-in-water emulsion is 6 to 10 wt %, it is preferable that the ratio of the saturated fatty acids to all constituent fatty acids in the oils and fats in the oil-in-water emulsion is less than 40 wt %, and with the above saturated fatty acid content, it is considered that the oils and fats form the better crystalline network, and the aging of the starches proceeds, so that the hardness suitable for the molding processing such as shredding or slicing can be imparted to the vegetable molded cheese-like food product.

(Oils and Fats)

As the oils and fats that can be used in the present invention, for example, oils and fats described in JP-T-2009-525735 can be used.

(Oils and Fats—SFC)

Further, in the vegetable molded cheese-like food product of the present invention, solid fat content (SFC) of the oils and fats in the oil-in-water emulsion is preferably 5% to 50%, and more preferably 20% to 40% at 20° C.

(Oils and Fats)

As such oils and fats, oils and fats that can be used for food can be widely adopted, and examples thereof include vegetable oils and fats such as rapeseed oil, soybean oil, sunflower oil, cottonseed oil, peanut oil, rice bran oil, corn oil, safflower oil, olive oil, kapok oil, sesame oil, evening primrose oil, palm oil, shea butter, sal fat, cacao fat, coconut oil, and palm kernel oil, animal oils and fats such as milk fat, beef tallow, lard, fish oil, and whale oil, and single or mixed oils of the above oils and fats or processed oils and fats obtained by subjecting them to hardening, fractionation, interesterification, and the like.

The vegetable molded cheese-like food product of the present invention can also contain, for example, a small amount of milk fat derived from butter, fresh cream, or the like as oils and fats other than the vegetable oils and fats, and can improve flavor of the vegetable molded cheese-like food product.

In addition, natural cheese and/or process cheese can be contained in the vegetable molded cheese-like food, and the flavor of the vegetable molded cheese-like food product can be further improved by containing a small amount of natural cheese and/or processed cheese.

However, in the case of preparing a vegetable molded cheese-like food product containing only vegetable raw materials, it is necessary to set the content of animal-derived oils and fats, natural cheese, and/or processed cheese to 0 wt %.

(Slip Melting Point)

In the vegetable molded cheese-like food product of the present invention, it is preferable to use oils and fats having a slip melting point of 5% to 50%, and preferably 20% to 40% at 20° C. from the viewpoint of the flavor and dissolution in the mouth.

(Starches)

The vegetable molded cheese-like food product of the present invention is the oil-in-water emulsion containing oils and fats, starch, and vegetable protein, the starch is not particularly limited, and examples thereof include starches obtained from corn, rice, potato, tapioca, pea, wheat, sweet potato, and the like, and modified starches such as phosphorylated starch, gelatinized starch, and hydroxypropylated starch of the starches.

(Protein)

The vegetable molded cheese-like food product of the present invention is the oil-in-water emulsion containing oils and fats, starch, and vegetable protein, but it does not mean that the animal raw materials are not contained at all, and the protein is not particularly limited, and vegetable proteins such as soybean protein, corn protein, wheat protein, and pea protein, and animal proteins such as casein, ovalbumin, milk protein, whey protein, gelatin, actin, myosin, and silk protein can be used. Polypeptides, peptides, amino acids, and the like may be used. All of the proteins may be vegetable proteins, animal proteins, or a mixture thereof.

The protein content in the vegetable molded cheese-like food product of the present invention is preferably 10 wt % or less, and more preferably 8 wt % or less.

When the protein content in the vegetable molded cheese-like food product is more than 10 wt %, a formulated viscosity during preparation of the cheese-like food product increases, and production may be difficult.

(Others)

The vegetable molded cheese-like food product of the present invention can further contain a thickener.

This can make it possible to further impart viscosity to the vegetable molded cheese-like food product, and to further improve suitability for the molding processing into shreds and the like.

The thickener is not particularly limited, and for example, agar, xanthan gum, guar gum, locust bean gum, karaya gum, tragacanth gum, carrageenan, gelatin, pectin, propylene glycol alginate, or an alginate can be used.

The vegetable molded cheese-like food product of the present invention can further contain an emulsifier to such an extent that the flavor is not impaired.

The emulsifier is not particularly limited, and conventionally known emulsifiers can be used, and examples thereof include lecithin, sucrose fatty acid ester, propylene glycol fatty acid ester, sorbitan fatty acid ester, glycerin fatty acid ester, polyglycerin fatty acid ester, various organic acid monoglyceride such as acetic acid monoglyceride, tartaric acid monoglyceride, acetic acid tartaric acid mixed monoglyceride, citric acid monoglyceride, diacetyl tartaric acid monoglyceride, and lactic acid monoglyceride, and polyoxyethylene sorbitan fatty acid ester.

The vegetable molded cheese-like food product of the present invention can contain known additives used for food products in addition to the above raw materials.

For example, pH adjusting agents such as phosphates, fragrances such as milk flavor and cheese flavor for the purpose of imparting flavor, various spices, fruit puree and jams, sweeteners such as sucralose, aspartame and stevia for the purpose of imparting sweetness, and colorants such as beta carotene, paprika dye and anato dye for the purpose of coloring can be used.

In addition, for the purpose of improving a shelf life, a shelf life improver such as glycine, sodium acetate, or egg white lysozyme can also be used.

Furthermore, the vegetable molded cheese-like food product of the present invention has, as physical properties, a hardness according to a rheometer measurement value at 5° C. of 400 g/19.6 mm² (5 mm diameter circular plunger, table speed 50 mm/min) or more, and more preferably 800 g to 2000 g/19.6 mm². The cheese-like food product having such physical properties has suitability for molding processing, and can be subjected to known processing such as cutting, dividing, mixing, or grinding to provide the molded cheese-like food product having a slice shape, a dice shape, a strip shape, a shred shape, or a powdered shape.

As a method for producing the vegetable molded cheese-like food product of the present invention, for example, an oil-in-water emulsion obtained by mixing oils and fats, starch, a protein raw material, maltodextrin, a thickener (modified starch), salt, yeast extract, a pH adjusting agent, and water is preliminarily emulsified and homogenized, and then produced through steps of sterilization and cooling.

At the time of preliminary emulsification, the pH is adjusted to 3.5 to 5.7 using an organic acid or an alkaline salt, but can also be adjusted by lactic acid fermentation of the oil-in-water emulsion.

The lactic acid fermentation is performed using a lactic acid bacterium starter at 15° C. to 45° C. until the pH reaches 3.5 to 5.7, and preferably 4 to 5.5.

When the pH is more than 5.5, the shelf life tends to be reduced, and when the pH is less than 4, acidic taste is strong, and a balance of the whole food is reduced when the food is used as the cheese-like food product, so that it is appropriate to adjust the pH within the above range.

Heat sterilization is performed for the purpose of gelatinizing the starches as well, and is preferably performed at 70° C. to 95° C.

### EXAMPLES

Hereinafter, the present invention will be described in more detail with reference to Examples. In Examples, both parts and % represent a weight basis.

(Preparation of Oils and Fats)

The following oils and fats I to X were prepared. Details of each oils and fats are shown in Table 1.

TABLE 1

| | |
|---|---|
| Oils and fats I | Oils and fats obtained by mixing 45% high oleic |
| | sunflower oil and 55% shea stearin |
| Oils and fats II | Oils and fats obtained by mixing 48% oils and fats I |
| | and 52% rapeseed oil |
| Oils and fats III | Oils and fats obtained by mixing 10% refined hardened |
| | coconut oil and 90% rapeseed oil |
| Oils and fats IV | Oils and fats obtained by mixing 72% refined hardened |
| | coconut oil and 28% rapeseed oil |
| Oils and fats V | Oils and fats obtained by mixing 88% interesterified |
| | oil and fat of coconut oil, palm high melting point |
| | fraction, and rapeseed extremely hardened oil and 12% |
| | rapeseed oil |
| Oils and fats VI | Oils and fats obtained by mixing 92% interesterified |
| | oil and fat of coconut oil, palm high melting point |
| | fraction, and rapeseed extremely hardened oil and 8% |
| | rapeseed oil |
| Oils and fats VII | Oils and fats obtained by mixing 8.5% refined |
| | hardened coconut oil and 91.5% rapeseed oil |
| Oils and fats VIII | Oils and fats obtained by mixing 70% rapeseed oil |
| | and 30% oils and fats I |
| Oils and fats IX | Oils and fats obtained by mixing 80% coconut oil |
| | and 20% rapeseed oil |
| Oils and fats X | Oils and fats obtained by mixing 80% refined |
| | hardened coconut oil and 20% rapeseed oil |

### Example 1

23 parts of oils and fats I, 37 parts of low-fat soy milk (produced by Fuji Oil Co., Ltd.), 11.5 parts of starch derived from potato or tapioca, 10.5 parts of starch derived from pea, 4.4 parts of maltodextrin, 3 parts of a thickener (modified starch), 1.5 parts of salt, 0.2 parts of yeast extract, 7.8 parts of water, and 1.1 parts of a pH adjusting agent containing lactic acid were blended at 55° C. for 10 minutes, and further homogenized under a pressure of 100 kg/cm′.

After homogenization, the mixture was passed through a scrape-type continuous heat exchanger, heat-sterilized at 80° C. to 90° C., then filled in a container for molding, rapidly cooled in a tunnel freezer, and then aged in a refrigerator (1° C. to 10° C.) for 3 days or more to obtain a vegetable molded cheese-like food product.

The physical properties and texture of the cheese-like food product were evaluated for quality.

The cheese-like food product had oils and fats content of 23 wt %, a saturated fatty acid content of 8.9 wt % in the oils and fats, a ratio of saturated fatty acids to all constituent fatty acids in the oils and fats of 38.6 wt %, an SFC of the oils and fats of 38% at 20° C., a pH of 5.4, and a hardness according to a rheometer measurement value at 5° C. of 800 g/19.6 mm² (5 mm diameter circular plunger, table speed 50 mm/min, manufactured by Rheotech Co., Ltd.), was excellent in suitability for the molding processing such as shredding, and had smooth dissolution in the mouth and a good flavor.

### Examples 2 to 6

In the same manner as in Example 1, vegetable molded cheese-like food products were prepared according to a formulation table in Table 2 below.

The SFC, the saturated fatty acid content, the ratio of the saturated fatty acids to all constituent fatty acids in the oils and fats, and results of sensory evaluation of Examples 1 to 6 are shown in Table 2.

TABLE 2

| | | Exam- | Exam- | Exam- | Exam- | Exam- | Exam- | Exam- | Exam- |
|---|---|---|---|---|---|---|---|---|---|
| | | ple 1 | ple 2 | ple 3 | ple 4 | ple 5 | ple 6 | ple 7 | ple 8 |
| Raw | Low-fat soy milk | 37.0 | | 37.0 | 37.0 | 37.0 | 32.0 | 37.0 | 37.0 |
| materials | Oat milk | | 37.0 | | | | | | |
| (parts) | Oils and fats I | 23.0 | 23.0 | | | | | | |
| | Oils and fats II | | | 30.0 | 30.0 | | | | |
| | Oils and fats III | | | | | 18.0 | 35.0 | | |
| | Oils and fats IV | | | | | | | 14.0 | |
| | Oils and fats V | | | | | | | | 10.0 |
| | Maltodextrin | 4.4 | 4.4 | | 2.8 | 12.0 | | 13.4 | 17.4 |
| | Salt | 1.5 | 1.5 | 1.5 | 1.5 | 1.5 | 1.5 | 1.5 | 1.5 |
| | Starch (derived | 10.5 | 10.5 | 10.5 | 10.5 | 10.5 | 10.5 | 10.5 | 10.5 |
| | from peas) | | | | | | | | |
| | Starch (derived from | 11.5 | 11.5 | 8.9 | 8.9 | 8.9 | 8.9 | 11.5 | 11.5 |
| | potato or tapioca) | | | | | | | | |
| | Modified starch | 3.0 | 3.0 | 3.0 | | 3.0 | 3.0 | 3.0 | 3.0 |
| | (derived from tapioca) | | | | | | | | |
| | Yeast extract | 0.2 | 0.2 | 0.2 | 0.2 | 0.2 | 0.2 | 0.2 | 0.2 |
| | Water | 7.8 | 7.8 | 7.8 | 7.8 | 7.8 | 7.8 | 7.8 | 7.8 |
| | pH adjusting agent | 1.1 | 1.1 | 1.1 | 1.1 | 1.1 | 1.1 | 1.1 | 1.1 |
| | Xanthan gum | | | | 0.1 | | | | |
| | Locust bean gum | | | | 0.1 | | | | |
| | Total | 100.0 | 100.0 | 100.0 | 100.0 | 100.0 | 100.0 | 100.0 | 100.0 |
| Com- | Oils and fats SFC in | 38 | 38 | 20 | 20 | 5.7 | 5.7 | 41.2 | 48.8 |
| position | oil-in-water emulsion | | | | | | | | |
| (%) | (20° C.) | | | | | | | | |
| | Saturated fatty acid | 8.9 | 8.9 | 7.0 | 7.0 | 2.8 | 5.5 | 9.8 | 6.6 |
| | content in oil-in-water | | | | | | | | |
| | emulsion | | | | | | | | |
| | Saturated fatty | 38.6 | 38.6 | 23.4 | 23.4 | 15.7 | 15.7 | 69.7 | 66.0 |
| | acids to all | | | | | | | | |
| | constituent fatty acids | | | | | | | | |
| | in oils and fats in | | | | | | | | |
| | oil-in-water emulsion | | | | | | | | |
| Quality | Hardness | 800 | 800 | 600 | 500 | 400 | 450 | 1000 | 2000 |
| evaluation | Melting in mouth | Excellent | Excellent | Excellent | Good | Good | Good | Good | Good |

### Comparative Examples 1 to 6

In the same manner as in Example 1, vegetable molded cheese-like food products were prepared according to a formulation table in Table 3 below.

The SFC, the saturated fatty acid content, the ratio of the saturated fatty acids to all constituent fatty acids in the oils and fats, and results of sensory evaluation of Comparative Examples 1 to 6 are shown in Table 3.

TABLE 3

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Raw | Low-fat soy milk | 37.0 | 37.0 | 37.0 | 37.0 | 37.0 | 37.0 |
| materials | Oils and fats V | 8.0 | | | | | |
| (parts) | Oils and fats VI | | 12.0 | | | | |
| | Oils and fats VII | | | 30.0 | | | |
| | Oils and fats VIII | | | | 14.5 | | |
| | Oils and fats IX | | | | | 19.0 | |
| | Oils and fats X | | | | | | 10.6 |
| | Maltodextrin | 19.4 | 15.4 | | 12.9 | 8.4 | 16.8 |
| | Salt | 1.5 | 1.5 | 1.5 | 1.5 | 1.5 | 1.5 |
| | Starch (derived from peas) | 10.5 | 10.5 | 10.5 | 10.5 | 10.5 | 10.5 |
| | Starch (derived from | 11.5 | 11.5 | 8.9 | 11.5 | 11.5 | 11.5 |
| | potato or tapioca) | | | | | | |
| | Modified starch (tapioca) | 3.0 | 3.0 | 3.0 | 3.0 | 3.0 | 3.0 |
| | Yeast extract | 0.2 | 0.2 | 0.2 | 0.2 | 0.2 | 0.2 |
| | Water | 7.8 | 7.8 | 7.8 | 7.8 | 7.8 | 7.8 |
| | pH adjusting agent | 1.1 | 1.1 | 1.1 | 1.1 | 1.1 | 1.1 |
| | Total | 100.0 | 100.0 | 100.0 | 100.0 | 100.0 | 100.0 |
| Com- | Oils and fats SFC in | 48.8 | 51 | 4.8 | 11.4 | 34.1 | 45.8 |
| position | oil-in-water emulsion | | | | | | |
| (%) | (20° C.) (%) | | | | | | |
| | Saturated fatty acid | 5.3 | 8.2 | 4.3 | 2.4 | 13.0 | 8.1 |
| | content in oil-in-water | | | | | | |
| | emulsion (%) | | | | | | |
| | Saturated fatty acids | 66.0 | 68.6 | 14.4 | 16.5 | 68.6 | 76.6 |
| | to all constituent fatty | | | | | | |
| | acids in oils and fats in | | | | | | |
| | oil-in-water emulsion | | | | | | |
| | (%) | | | | | | |
| Quality | Hardness | 1500 | 1800 | 200 | 100 | 1350 | 1500 |
| evaluation | Melting in mouth | Average | Average | Average to | Average to | Good | Average |
| | | | | Poor | Poor | | |

1. A vegetable molded cheese-like food product which is an oil-in-water emulsion containing oils and fats of 10 to 40 wt %, starch, and a vegetable protein, wherein
SFC of the oils and fats is 5% to 50% at 20° C., saturated fatty acid content is 2.5 to 10 wt %, a ratio of saturated fatty acids to all constituent fatty acids in the oils and fats is less than 70 wt %, and a hardness according to a rheometer measurement value at 5° C. of the oil-in-water emulsion is 400 g/19.6 mm′ (5 mm diameter circular plunger, table speed 50 mm/min) or more.

2. A vegetable molded cheese-like food product obtained by cutting the vegetable molded cheese-like food product according to claim 1 and having a slice shape, a dice shape, a strip shape, or a shred shape.

3. The vegetable molded cheese-like food product according to claim 1, comprising only vegetable raw materials.
